(19) United States
(12) Patent Application Publication
(10) Pub. No.: US 2016/0007804 A1
(43) Pub. Date: Jan. 14, 2016

(54) PERSONAL PEANUT SHELLER

(71) Applicant: NORTHEASTERN UNIVERSITY, Boston, MA (US)

(72) Inventors: Justin Evans, Whitman, MA (US); William Haugh, Vienna, VA (US); Michael Minerbi, Bethesda, MD (US); Alary Price, Hillsborough, NJ (US); Sinan Müftü, Chestnut Hill, MA (US)

(73) Assignee: Northeastern University, Boston, MA (US)

(21) Appl. No.: 14/771,645

(22) PCT Filed: Mar. 4, 2014
(86) PCT No.: PCT/US2014/020181

§ 371 Date: Aug. 31, 2015

Related U.S. Application Data
(60) Provisional application No. 61/773,038, filed on Mar. 5, 2013.

(51) Int. Cl. A47J 43/26

(52) U.S. Cl. CPC A47J 43/26

(57) ABSTRACT

Described herein is a nut shelling device and method of manufacturing a nut shelling device that includes a cylindrical housing, a drum positioned in the cylindrical housing, an actuating cap rotatably coupled to the cylindrical housing and coupled to the drum, a containment receptacle coupled to the cylindrical housing, a first sieve coupled to the cylindrical housing, and a second sieve positioned in the containment receptacle.

### CROSS-REFERENCE TO RELATED APPLICATION

The present application claims priority to U.S. Provisional Patent Application No. 61/773,038, filed Mar. 5, 2013 and entitled “PERSONAL PEANUT SHELLER,” which application is incorporated herein by reference in its entirety.

### TECHNICAL FIELD

The present disclosure is related generally to devices for shelling nuts.

### BACKGROUND

Nuts, such as peanuts, are a popular snack and for some a staple product in view of the high protein, vitamin, and antioxidant content of the nuts. Obtaining out-of-shell peanuts may be difficult for underdeveloped or geographic regions that are still developing and have limited manufacturing resources. Additionally, some consumers who readily have access to out-of-shell peanuts simply prefer the taste, condition, and/or purchase price of nuts that are in-shell rather than out-of-shell or pre-shelled nuts.

Whether consuming in-shell peanuts because of preference or because of availability, personal consumption of in-shell peanuts may require individually splitting the nuts by hand, a process that may be painful, tedious, and messy.

### SUMMARY

Various embodiments provide nut shelling devices and methods of manufacturing and implementing nut shelling devices. In particular embodiments, a nut shelling device includes a cylindrical housing including a plurality of housing protrusions extending radially inward from an inner wall of the cylindrical housing. The nut shelling device also includes a drum positioned in the cylindrical housing. The drum is configured to rotate with respect to the cylindrical housing about an axis. The drum includes a plurality of drum protrusions extending radially outward from an outer wall of the drum. At least one of the drum and the inner wall of the cylindrical housing are tapered to form a tapered volume between the drum and the inner wall of the cylindrical housing, the tapered volume decreasing in cross sectional area along the axis. The nut shelling device further includes an actuating cap rotatably coupled to the cylindrical housing and coupled to the drum. The nut shelling device includes a containment receptacle coupled to the cylindrical housing and a first sieve coupled to the cylindrical housing between at least a portion of the containment receptacle and at least a portion of the drum. The first sieve includes a first plurality of first openings. The nut shelling device also includes a second sieve positioned in the containment receptacle between the first sieve and at least a portion of the containment receptacle. The second sieve includes a second plurality of second openings. The second openings are smaller than the first openings.

In particular embodiments, the plurality of housing protrusions and the plurality of drum protrusions include diamond shaped protrusions. The actuating cap may be removably coupled to the outer cylindrical housing. The actuating cap may be removably coupled to the drum. In particular embodiments, the actuating cap includes a first inlet opening configured to receive nuts. The actuating cap includes a cylindrical housing hub configured to surround an outer portion of the cylindrical housing in accordance with particular embodiments. The cylindrical housing may include a hub configured to surround an outer portion of the actuating cap. In accordance with particular embodiments, at least one of the actuating cap and the drum includes a coupling socket and the other one of the actuating cap and the drum includes a coupling shaft. The coupling socket includes an opening having a cross section corresponding to cross section of the barrel shaft. In particular embodiments, the cross section includes a polygon. The containment receptacle may be removably coupled to the cylindrical housing via threaded formations disposed on the cylindrical housing and the containment receptacle. In particular embodiments, the drum is composed of a polymer. The actuating cap includes a motor, in accordance with particular embodiments. The nut shelling device may also include a blower disposed within at least one of the cylindrical housing and the containment receptacle.

Other various embodiments provide a method of manufacturing a nut shelling device that includes positioning a drum in a cylindrical housing. The cylindrical housing includes a plurality of housing protrusions extending radially inward from an inner wall of the cylindrical housing. The drum is configured to rotate with respect to the cylindrical housing about an axis. The drum includes a plurality of drum protrusions extending radially outward from an outer wall of the drum. At least one of the drum and the inner wall are tapered to form a tapered volume between the drum and the inner wall of the cylindrical housing decreasing in cross sectional area along the axis. The method also includes coupling an actuating cap to the cylindrical housing and the drum, such that the actuating cap is rotatable with respect to the cylindrical housing. The method further includes coupling a containment receptacle to the cylindrical housing. The method includes coupling a first sieve to the cylindrical housing between at least a portion of the containment receptacle and at least a portion of the drum. The first sieve includes a first plurality of first openings. The method also includes coupling a second sieve to the containment receptacle between the first sieve and at least a portion of the containment receptacle. The second sieve includes a second plurality of second openings. The second openings are smaller than the first openings.

In particular embodiments of the method of manufacturing, the plurality of housing protrusions and the plurality of drum protrusions include diamond shaped protrusions. The actuating cap may be removably coupled to the outer cylindrical housing. The actuating cap may be removably coupled to the drum. In particular embodiments, the actuating cap includes a cylindrical housing hub configured to surround an outer portion of the cylindrical housing. At least one of the actuating cap and the drum include a coupling socket and the other one of the actuating cap and the drum include a barrel shaft in accordance with particular embodiments. The coupling socket has an opening having a cross section corresponding to a cross section of the barrel shaft. In particular embodiments, the containment receptacle is removably coupled to the cylindrical housing via threaded formations disposed on the cylindrical housing and the containment receptacle.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of the present disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a perspective view of a nut shelling device according to one embodiment of the present disclosure.

FIG. 2 is a side view of the nut shelling device of FIG. 1.

FIG. 3 is a cross-sectional view of the nut shelling device of FIG. 1.

FIG. 4 is an exploded view of the nut shelling device of FIG. 1.

FIGS. 5A and 5B illustrate attachment of upper and lower sieves to the nut shelling device of FIG. 1.

FIG. 6 is a partially transparent side view of a nut shelling device according to one embodiment of the present disclosure.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive nut shelling devices and methods of manufacturing and implementing nut shelling devices. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

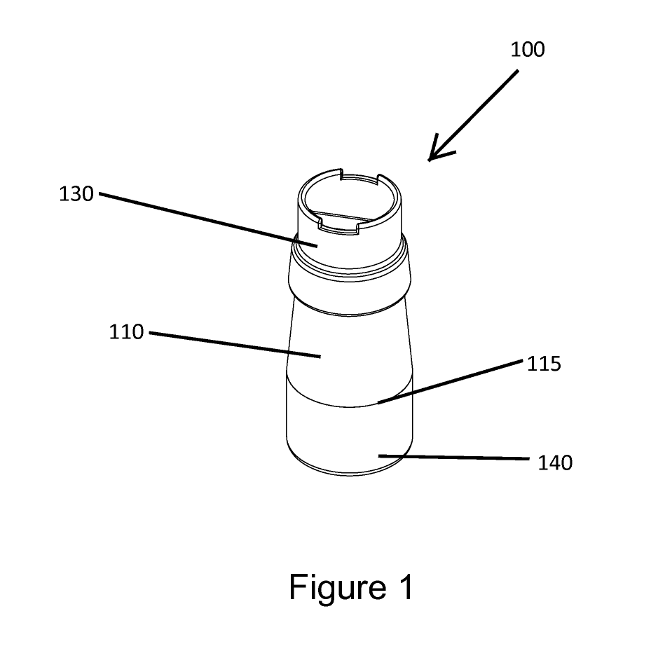

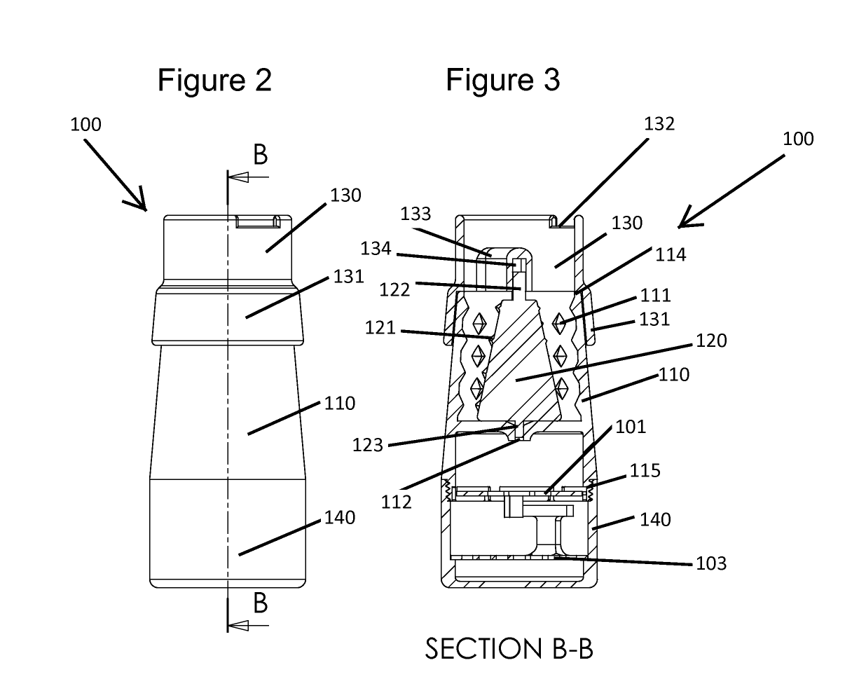

FIG. 1 is a perspective view of a nut shelling device according to one embodiment of the present disclosure and FIG. 2 is a side view of the nut shelling device of FIG. 1. The nut shelling device 100 includes a cylindrical housing 110, an actuating cap 130 positioned on top of the cylindrical housing 110, and a containment receptacle 140 coupled to the cylindrical housing 110 at a base 115 of the cylindrical housing 110.

FIG. 3 is a cross-sectional view of the nut shelling device of FIG. 1 As further demonstrated in FIG. 2, the nut shelling device also includes a drum 120 positioned in the cylindrical housing 110. In the illustrated embodiment, drum 120 is tapered or conical and includes a plurality of drum protrusions 121 extending radially outward and generally orthogonal from an outer wall 124 of the drum 120. The drum 120 may be composed of a material including, but not limited to, polymethyl methacrylate (PMMA), polyethylene terephthalate (PET), acrylic, and polycarbonate (PC) as well as other polymers. In the illustrated example embodiment, the plurality of drum protrusions 121 includes a raised diamond or pyramid shape. The plurality of drum protrusions 121 may be configured in another shape, including but not limited to a wire mesh, raised rectangular bars, or other geometric configuration. The drum protrusions 121 are generally arranged in a staggered configuration. The drum protrusions 121 may have spacing configured to accommodate a particular kind of nut being shelled. The drum protrusions 121 may be composed of the same material as the drum 120 in various embodiments and may be composed of a different material, such as harder material inserted into the drum in accordance with various embodiments. In various embodiments, the drum 120 also includes a coupling shaft 122. In the illustrated embodiment, coupling shaft 122 includes a square shaped cross section. In various embodiments, coupling shaft 122 may include a round shafting having a cross-member such as pin configured for locking the shaft into an opening 134 of a coupling socket 133 of the actuating cap 130. The drum 120 may also include an axle 123 to facilitate rotating the drum 120 with respect to the cylindrical housing 110. The cylindrical housing 110 may include a corresponding axle bearing socket 112 configured to receive the axle 123 for rotation within the axle bearing socket 112. In various embodiments, the cylindrical housing 110 may include the axle bearing socket and the drum 120 may include the axle 123. The axle 123 is co-axial with an axis about which the drum 120 may rotate with respect to the cylindrical housing 110.

As depicted in the embodiment illustrated in FIGS. 1-5, the cylindrical housing 110 may include a tapered wall, which may include an inner tapered wall 116 having a plurality of cylinder housing protrusions 111 extending radially inward from inner tapered wall 116. In accordance with example embodiments, the cylindrical housing may include an untapered wall or the drum 120 may include an untapered wall so long as at least one of inner wall 116 of the cylindrical housing 110 and the outer wall 124 of the drum 120 is tapered such that a tapered volume 117 is formed between the drum and the inner wall of the cylindrical housing decreasing in cross sectional area along the axis. The tapered volume 117 facilitates shelling nuts disposed therein as discussed further herein.

The actuating cap 130 is generally rotatably coupled to the crown 114 of the cylindrical housing 110. As demonstrated, the actuating cap 130 may include a hub 131 configured to surround an outer portion of the cylindrical housing 110. Hub 131 helps maintain concentric rotation of actuating cap 130 about the cylindrical housing as the actuating cap is rotated coaxially with the drum 120. As noted herein, actuating cap 130 includes an opening 134 of a coupling socket 133. Coupling socket 133 and opening 134 facilitate fixably coupling the actuating cap 130 to the drum 120. As such, when actuating cap 130 is rotated, for example via a user turning the actuating cap by hand, the drum 120 is rotated within the cylindrical housing 110, to facilitate shelling peanuts disposed in the tapered volume between the of inner wall 116 of the cylindrical housing 110 and the outer wall 124 of the drum 120. Actuating cap 130 includes an inlet opening 132 for receiving nuts, such as peanuts into the nut shelling device 100. As the actuating cap 130 turns the drum 120 with respect to the cylindrical housing 110, the nuts descend through the tapered volume 117 and the shells of the nuts disposed in the tapered volume 117 are cracked by the abrasion of the cylinder housing protrusions 111 and the drum protrusions 121 rotating with respect to one another. In various embodiments, the actuating cap 130 may include one or more contours configured as hand or finger grips to facilitate grasping by the user during turning of the actuating cap 130.

As the shells of the nuts are cracked, the kernels are separated from the shells and both the kernels and the shells descend through the cylindrical housing 110. The nut shelling device 100 includes a first sieve 101 coupled to the cylindrical housing generally below the drum 120. The first sieve 101 includes a plurality of holes 102. The holes 102 help separate the cracked shells from the kernels. The holes 102 are sized to allow whole kernels to pass through and prevent shell portions that are larger than the whole kernels from passing through the first sieve 101. Accordingly, the first sieve 101 may be removably coupled to the cylindrical housing to permit a sieve having differently sized holes, in accordance with the desired nut being shelled to be positioned therein. After the kernels and small shell portions traverse the first sieve 101 they descend into a containment receptacle 140. Containment receptacle 140 includes a second sieve 103 that includes a plurality of holes 104. Holes 104 are smaller than holes 102, such that kernels remain on top of the second sieve 103 within the containment receptacle 140 and such that shell portions that are smaller than the kernels and other debris fall through the second sieve 103. For example, in one embodiment holes 102 are approximately 0.450 inches and holes 104 are approximately 0.275 inches. In the illustrated embodiment, the containment receptacle 140 is removably coupled to the cylindrical housing 110 via threaded formations including male threaded formation 113 on the cylindrical housing 110 and female threaded formation 142 on the containment receptacle 140.

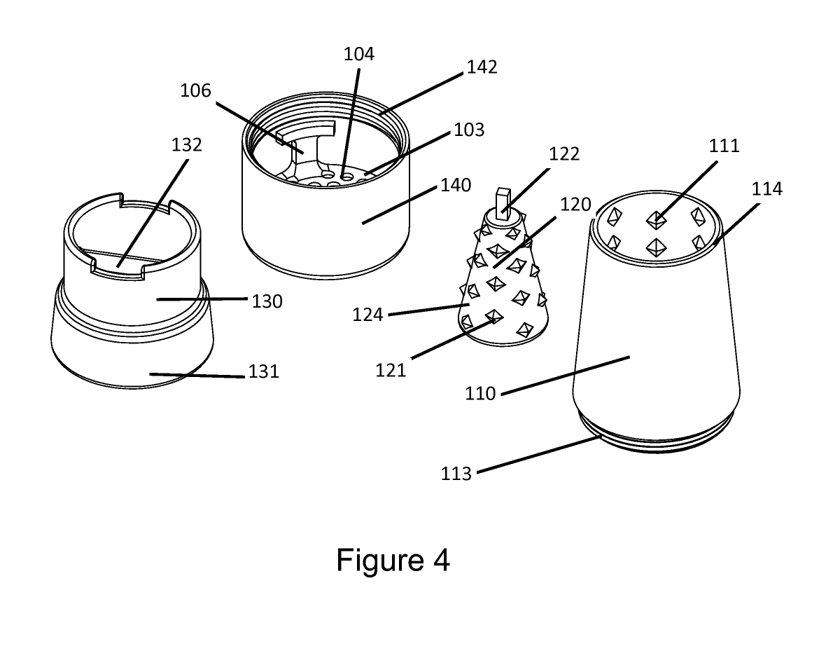

FIG. 4 is an exploded view of the nut shelling device of FIG. 1. FIG. 4 illustrates the cylindrical housing 110, the drum 120, the actuating cap 130, and the containment receptacle 140 separated from one another. In accordance with exemplary embodiments, the components may be separated as shown for cleaning, repair, replacement, etc.

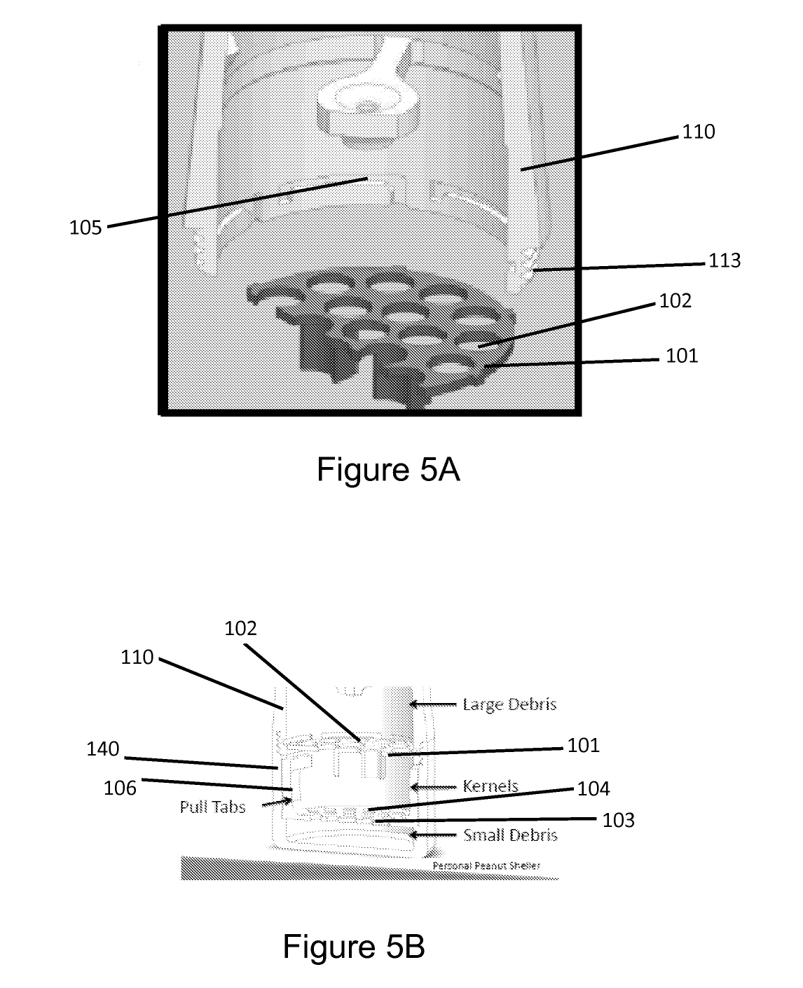

FIGS. 5A and 5B illustrate attachment of the upper and lower sieves to the nut shelling device of FIG. 1. As illustrated in FIG. 5A, the cylindrical housing 110 may include one or more channels 105 configured to receive the first sieve 101 and couple the first sieve 101 to the cylindrical housing 110. The channels 105 may be structured for a lift or push and twist motion to lock the first sieve 101 into place in the cylindrical housing 110. In some embodiments the first sieve 101 may be positioned with an upper portion of the containment receptacle. As illustrated in FIG. 5B, the second sieve 103 may include one or more pull tabs 106 for separating the second sieve 103 from the containment receptacle 140, such that nuts may be removed and/or the debris between the bottom of the containment receptacle 140 and the second sieve 103 may be emptied. In various embodiments, the containment receptacle may include an opening to permit retrieval of the kernels from the containment receptacle 140 without removal of the containment receptacle 140 from the cylindrical housing 110.

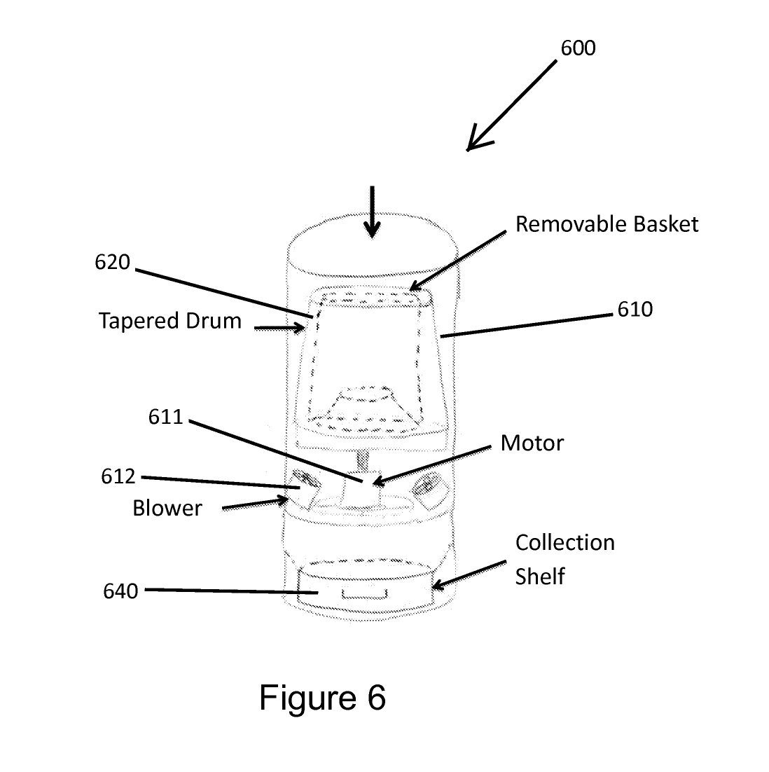

In various embodiments, the nut shelling device may include various electrical components configured to facilitate shelling and separation. For example, the nut shelling device 100 may include an actuation motor, such as a motor which may be disposed in actuating cap 130 to rotate the drum 120 with respect to the cylindrical housing 110 via shaft 122. The nut shelling device 100 may also include one or more blower motors, which may be disposed in the cylindrical housing 110 to facilitate separation of small shell portions or debris from the large and/or whole kernel chunks. FIG. 6 provides an exemplary embodiment of a nut shelling device including the aforementioned components.

FIG. 6 is a side view of a nut shelling device according to one embodiment of the present disclosure. The nut shelling device 600 illustrated in FIG. 6 includes a cylindrical housing 610 and a drum 620 disposed therein. Drum 620 is tapered and configured with a hollow center. Drum 620 may include a plurality of drum protrusions and the inner wall of cylindrical housing 610 may include a plurality of housing protrusions, which may be raised diamond shaped protrusions. Nut shelling device 600 may also include an electrical motor 611 coupled to the drum 620 for moving the drum 620 with respect to the cylindrical housing 610. Nut shelling device 600 may also include one or more electrical blowers 612. The electrical blowers 612 may be positioned to blow at an angle vertically upward to push the lighter shelled fragments into the hollow section of the drum 620 while allowing kernels to drop into containment receptacle 640.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other example embodiments, and that such variations are intended to be encompassed by the present disclosure. It is recognized that features of the disclosed embodiments can be incorporated into other disclosed embodiments.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

It is important to note that the constructions and arrangements of apparatuses or the components thereof as shown in the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A nut shelling device comprising:
a cylindrical housing, including a plurality of housing protrusions extending radially inward from an inner wall of the cylindrical housing;
a drum positioned in the cylindrical housing, the drum configured to rotate with respect to the cylindrical housing about an axis, the drum including a plurality of drum protrusions extending radially outward from an outer wall of the drum, wherein at least one of the drum and the inner wall of the cylindrical housing are tapered to form a tapered volume between the drum and the inner wall of the cylindrical housing decreasing in cross sectional area along the axis;
an actuating cap rotatably coupled to the cylindrical housing and coupled to the drum;
a containment receptacle coupled to the cylindrical housing;
a first sieve coupled to the cylindrical housing between at least a portion of the containment receptacle and at least a portion of the drum, the first sieve including a first plurality of first openings; and
a second sieve positioned in the containment receptacle between the first sieve and at least a portion of the containment receptacle, the second sieve including a second plurality of second openings, wherein the second openings are smaller than the first openings.

2. The nut shelling device of claim 1, wherein the plurality of housing protrusions and the plurality of drum protrusions include diamond shaped protrusions.

3. The nut shelling device of claim 1, wherein the actuating cap is removably coupled to the outer cylindrical housing.

4. The nut shelling device of claim 1, wherein the actuating cap is removably coupled to the drum.

5. The nut shelling device of claim 1, wherein the actuating cap includes a first inlet opening configured to receive nuts.

6. The nut shelling device of claim 1, wherein the actuating cap includes a cylindrical housing hub configured to surround an outer portion of the cylindrical housing.

7. The nut shelling device of claim 1, wherein the cylindrical housing includes a hub configured to surround an outer portion of the actuating cap.

8. The nut shelling device of claim 1, wherein at least one of the actuating cap and the drum includes a coupling socket and the other one of the actuating cap and the drum includes a coupling shaft, the coupling socket having an opening having a cross section corresponding to a cross section of the coupling shaft.

9. The nut shelling device of claim 1, wherein the cross section is a polygon.

10. The nut shelling device of claim 1, wherein the containment receptacle is removably coupled to the cylindrical housing via threaded formations disposed on the cylindrical housing and the containment receptacle.

11. The nut shelling device of claim 1, wherein the drum is composed of a polymer.

12. The nut shelling device of claim 1, wherein the actuating cap includes a motor.

13. The nut shelling device of claim 1, further comprising a blower disposed within at least one of the cylindrical housing and the containment receptacle.

14. A method of manufacturing a nut shelling device comprising:
positioning a drum in a cylindrical housing, the cylindrical housing including a plurality of housing protrusions extending radially inward from an inner wall of the cylindrical housing, the drum configured to rotate with respect to the cylindrical housing about an axis, the drum including a plurality of drum protrusions extending radially outward from an outer wall of the drum, where at least one of the drum and the inner wall are tapered to form a tapered volume between the drum and the inner wall of the cylindrical housing decreasing in cross sectional area along the axis;
coupling an actuating cap to the cylindrical housing and the drum, such that the actuating cap is rotatable with respect to the cylindrical housing;
coupling a containment receptacle to the cylindrical housing;
coupling a first sieve to the cylindrical housing between at least a portion of the containment receptacle and at least a portion of the drum, the first sieve including a first plurality of first openings; and
coupling a second sieve to the containment receptacle between the first sieve and at least a portion of the containment receptacle, the second sieve including a second plurality of second openings, wherein the second openings are smaller than the first openings.

15. The method of manufacturing according to claim 14, wherein the plurality of housing protrusions and the plurality of drum protrusions include diamond shaped protrusions.

16. The method of manufacturing according to claim 14, wherein the actuating cap is removably coupled to the outer cylindrical housing.

17. The method of manufacturing according to claim 14, wherein the actuating cap is removably coupled to the drum.

18. The method of manufacturing according to claim 14, wherein the actuating cap includes a cylindrical housing hub configured to surround an outer portion of the cylindrical housing.

19. The method of manufacturing according to claim 14, wherein at least one of the actuating cap and the drum includes a coupling socket and the other one of the actuating cap and the drum includes a coupling shaft, the coupling socket having an opening having a cross section corresponding to a cross section of the coupling shaft.

20. The method of manufacturing according to claim 14, wherein the containment receptacle is removably coupled to the cylindrical housing via threaded formations disposed on the cylindrical housing and the containment receptacle.
